(19) United States
(12) Patent Application Publication
(10) Pub. No.: US 2009/0054815 A1
(43) Pub. Date: Feb. 26, 2009

(54) Aided intervertebral muscle strenghthener

(76) Inventor: Betty Jane Briscoe, Freeport, NY (US)

Correspondence Address: Betty Jane Briscoe, 353 W. Merrick Rd., Freeport, NY, 11520, US

(21) Appl. No.: 12/080,545

(22) Filed: Apr. 3, 2008

Related U.S. Application Data
(60) Provisional application No. 60/965,460, filed on Aug. 21, 2007.

(51) Int. Cl. A61H 7/00

(52) U.S. Cl. 601/134

(57) ABSTRACT

A portable back strengthening device 22 with weight resistance that an aide applies to a user's back. The aide will roll the device in a repeated head to toe motion while a user lies in a prone position. During this operation, foam cushion 16 spins freely around metal pole 12 which has metal weight 18 centrally mounted within its' axis that provides a weight resistance to a user's back structures. The foam cushion 16 contour adequately provides a firm contact surface for all back structures. This device distributes weight resistance evenly to a user's back, thereby providing optimum dorsal muscle strengthening.

### CROSS-REFERENCE TO RELATED APPLICATIONS

This application claims the benefit of provisional patent application Ser. No. 60/965,460, filed 2007 Aug. 21 by the present inventor.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to back strengthening devices, specifically to such which use weight resistance during operation.

2. Prior Art

A consumer purchases back strengthening equipment in order to exercise and strengthen all of their back muscles. Ultimately, these devices should be capable of strengthening all dorsal, muscle groups.

Indeed, several designs of back strengthening devices were invented. However, these former designs only partially strengthen dorsal structures. This is clearly shown in U.S. Pat. No. 5,618,250 to Butz (1997) and U.S. Pat. No. D439,938 S to Batca (2001) wherein, both machines lack a cushion that makes total contact with all back structures. These cushions fail to rotate along the entire spinal column or all back structures. Ultimately, these devices only slightly activate the partial strengthening of back muscles.

Thus a later back strengthening machine depicts similar lacking design features-in example U.S. Pat. No. 6,387,024 B1 to Monti (2002). This back strengthening apparatus clearly fails to make contact with all dorsal muscle groups. The absurd shape of its back strengthening rolling cushions is two lateral components, which lack a continuous contact surface for all dorsal structures. Indeed, they fall short of any surface contact for the spinal column. Nor do these lateral cushions roll along the entire back thereby ignoring the lumbar region and lower back structures.

Conclusively, heretofore-back strengthening machines render subsequent users to succumb nonetheless, into an unbalanced strengthening of back muscles. Therefore, the need still exists for a back strengthening machine that can apply equal weight resistance to all dorsal structures.

3. Objects and Advantages

Accordingly, besides the advanced structural aspects and optimum dorsal exercise technique of the back strengthening device in my above patent, several objects and advantages of the present invention are:
(a) to provide a back strengthening device which can be produced in a series of variable weight resistance;
(b) to provide a back strengthening device whose rolling cushion contour will adequately make firm contact with all back structures;
(c) to provide a back strengthening device whose embodied weight resistance will sufficiently exercise all dorsal muscle groups;
(d) to provide a back strengthening device which is applied by an assistant while a user lays in a relaxed prone-face down position;
(e) to provide a back strengthening device which is portable and easily loaded into luggage for travel convenience?

### SUMMARY

In accordance with the present invention a back strengthening device comprises a metal pole with a central metal weight resistance embodiment, a solid plastic tube covered with foam cushion, two side sleeves, and two rubber hand grips.

### DRAWINGS—FIGURES

FIG. 1 shows a top perspective right-side view thereof, the right side being a mirror image, of a back strengthening device constructed in accordance with the invention.

FIG. 2 shows a top perspective view of the metal tubing with the central metal weight resistance embodiment in transparent view.

FIG. 3 shows a top perspective view of the plastic tube.

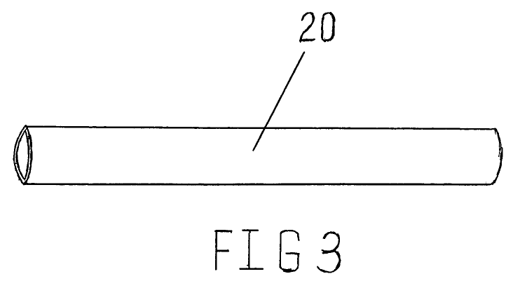

FIG. 4 shows a front perspective view of the foam cushion.

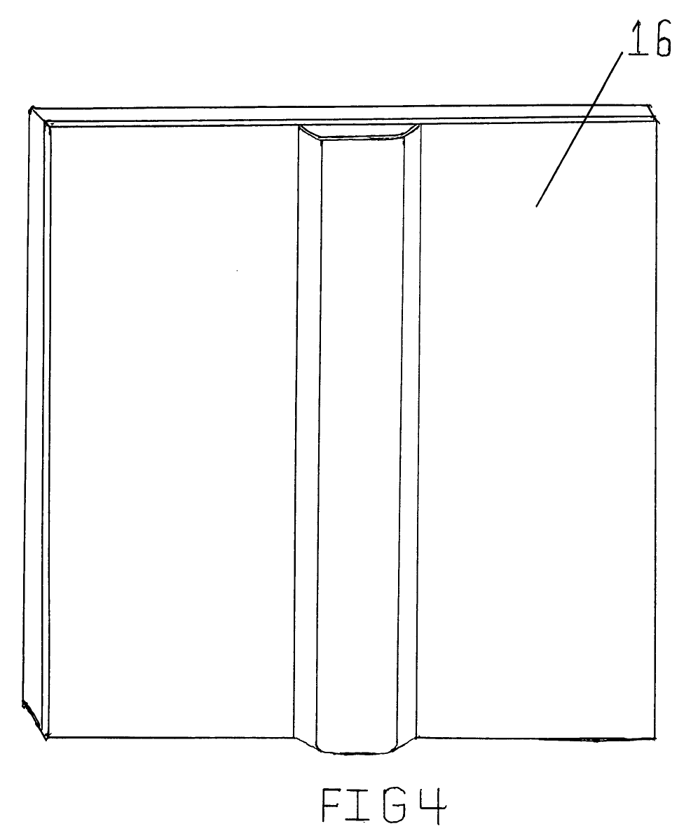

FIG. 5 shows a perspective right-side view of the sleeves.

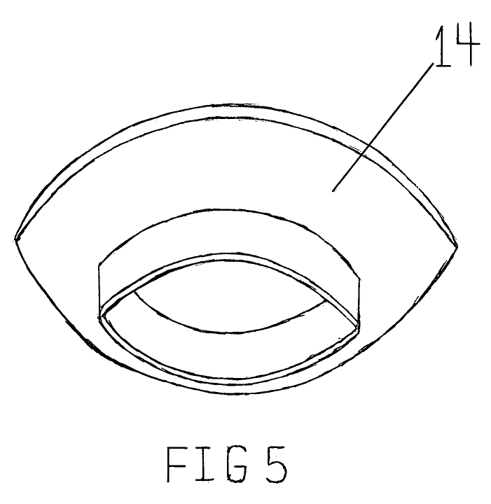

FIG. 6 shows a top perspective view of the foam handgrips.

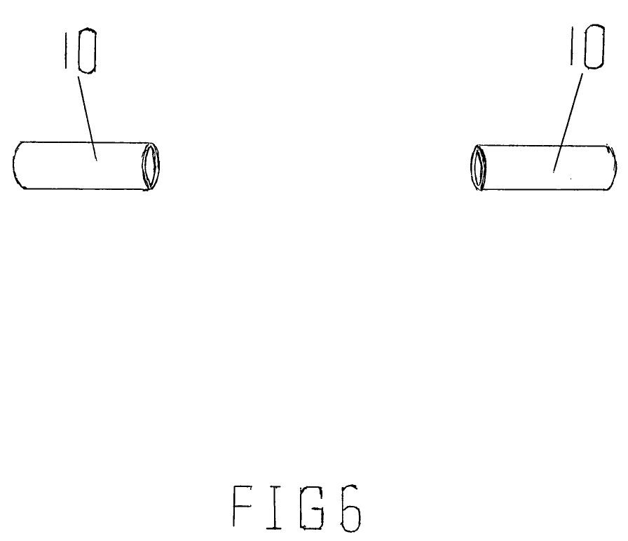

### DRAWINGS—REFERENCE NUMERALS

10 foam handgrip

12 metal pole

14 sleeve

16 foam cushion

18 metal weight

20 plastic tube

22 back strengthening device

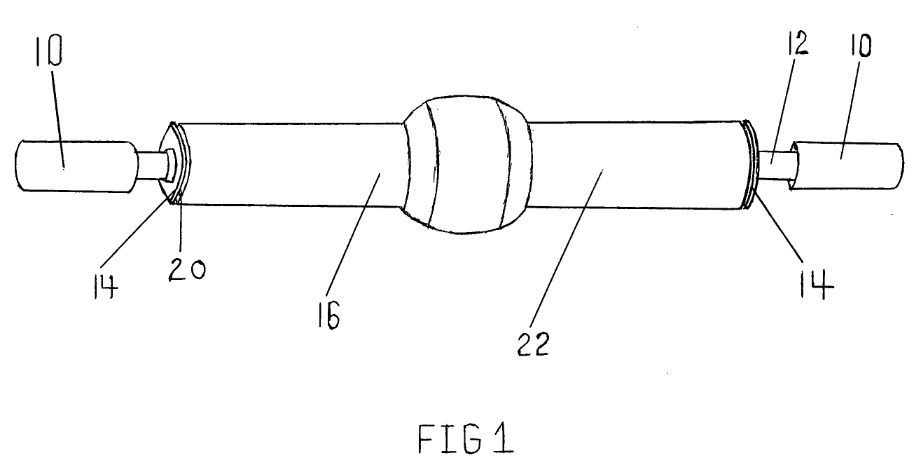

### DETAILED DESCRIPTION—FIG. 1—PREFERRED EMBODIMENT

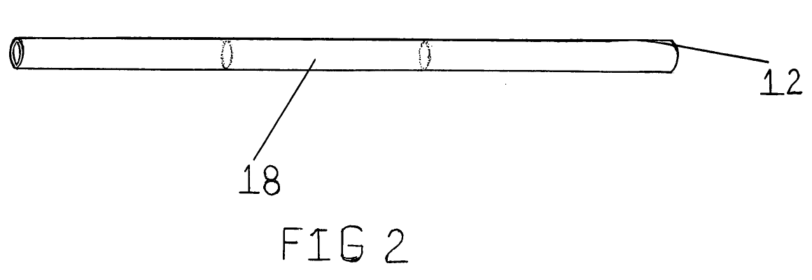

A preferred embodiment of the back strengthening device of the present invention is illustrated in FIG. 1. A foam cushion 16 is adhered to an underlying plastic tube 20, which freely spins around metal pole 12. The metal pole 12 has a metal weight 18 (FIG. 2) centrally mounted within its axis. Metal sleeve 14 slides onto opposite sides of metal pole 12, thereby restricting the rolling cushion to a centralized location. Tightly fitted foam handgrips 10 slide onto opposite sides of metal pole 12.

### OPERATION—FIG. 1

The manner of using the aided intervertebral muscle strengthener is an innovative back muscle strengthening technique. First, a user will lie in a prone face downward position, preferably on a bed or massage table. Next, an aide will hold onto handgrips 10 and apply the back strengthening device onto a user's back. Now the aide will roll the foam cushion 16 up and down the receiver's back, in a head to toe repeated motion. Thereby, a weight resistance is evenly distributed to all back structures as the foam cushion 16 spins freely around metal pole 12.

I claim:

1. A portable back strengthening device having a rolling cushion with an embodied inner centralized metal pole weight resistance unit.

2. The portable back strengthener of claim 1 is operated by an aide during whom a neck to coccyx motion is repeated on a user's back.

3. The device of claim 1 wherein said rolling cushion will spin freely around said metal pole weight resistance unit during said operation.

4. The device of claim 3 wherein said operation will apply an even amount of weight resistance to all of a user's back structures.

5. The device of claim 4 wherein said all of a user's back structures will become strengthened as a result of said operation performed by said aide.
